(19) United States
(12) Patent Application Publication
(10) Pub. No.: US 2009/0129999 A1
(43) Pub. Date: May 21, 2009

(54) METHOD OF BRAZING A FIRST METAL MEMBER TO A SECOND METAL MEMBER USING A HIGH WETTABILITY METAL AS LAYER BETWEEN THE TWO METAL MEMBERS; REFORMER MANUFACTURED BY THIS METHOD, THE METAL MEMBERS HAVING GROOVES

(75) Inventors: Takashi Shimazu, Aichi-ken (JP); Kenji Kimura, Aichi-ken (JP)

Correspondence Address: OBLON, SPIVAK, MCCLELLAND MAIER & NEUSTADT, P.C., 1940 DUKE STREET, ALEXANDRIA, VA, 22314, US

(73) Assignee: TOYOTA JIDOSHA KABUSHIKI KAISHA, Toyota-shi ,Aichi-ken (JP)

(21) Appl. No.: 12/295,633

(22) PCT Filed: Apr. 27, 2007
(86) PCT No.: PCT/IB2007/001108

§ 371 Date: Oct. 1, 2008

(30) Foreign Application Priority Data
Apr. 28, 2006 (JP) 2006-125784

(51) Int. Cl. B01J 8/02; B23K 35/22

(52) U.S. Cl. 422/190; 228/245

(57) ABSTRACT

A method for brazing a first metal member, on which an oxide forms during brazing, and a second metal member, in which a high-wettability metal having a wettability with a brazing filler metal that is higher than that of the oxide is applied to at least a brazing surface of the first metal member. The first metal member and the second metal member are then joined by heating the brazing filler metal to melt the brazing filler metal. The oxide covering film is formed on the portion of the surface of the first metal member to which the high-wettability metal was not applied.

### BACKGROUND OF THE INVENTION

1. Field of the Invention

The present invention relates to a method for brazing members of the same or different compositions. In particular, it relates to a method for brazing to a metal member having reduced wettability caused by the formation of oxides during the brazing.

2. Description of the Related Art

When brazing members of the same or different composition, a brazing filler metal is applied between the member to be brazed and the receiving member to which the member is to be brazed, after which the members overall are heated or the joining location is heated to the brazing temperature to melt the brazing filler metal and join (braze) the members. Methods of applying the brazing filler metal that are used include, for example, thermal spraying of a brazing filler metal covering film on the brazing surface (refer to Japanese Patent Application Publications No. JP-A-7-108372 and JP-A-62-214865), spot welding to hold a brazing foil onto the brazing surface (refer to Japanese Patent Application Publication No. JP-A-4-143066), and coating a powdered brazing filler metal onto the brazing surface.

In the foregoing methods, the temperature for melting the applied brazing filler metal is very high, for example, the brazing temperature for nickel-based brazing filler metal generally being approximately 1000° C. For this reason, depending upon the material of the member to be brazed, heating of the member to be brazed to a high temperature sometimes causes an oxide to form on the member being brazed. For example, heating a member containing a large amount of aluminum to a high temperature when brazing causes an alumina layer to form on the surface of the member. Because alumina is highly stable, it maintains good corrosion resistance even in an oxidizing atmosphere. However, because of the low wettability between alumina and the brazing filler metal, when the brazing filler metal melts on the surface of the alumina layer, the brazing filler metal is repelled, which may cause pores to form at the joint after coagulation of the brazing filler metal, or cracks at the joint, causing partially poor joining.

Depending upon the application of the brazed assembly, while there are cases in which it is sufficient if the structure formed by brazing is maintained, the foregoing poor joining does not represent that great a problem. However, in the case, for example, of a fuel reformer for the purpose of generating hydrogen, because it is necessary to prevent hydrogen leaks at several hundred brazed joint locations, it is important to reduce the poor joining that occurs because of insufficient wetting of the brazing filler metal.

### SUMMARY OF THE INVENTION

The present invention provides a method for brazing that reduces the occurrence of poor joining, even under circumstances where oxides are formed during brazing and wettability is reduced in the brazing.

A first aspect of the present invention relates to a method for brazing a first metal member on which an oxide forms during brazing and a second metal member. The brazing method has a metal application step of applying a high-wettability metal to at least the brazing surface of the first metal member, wherein the high-wettability metal has a wettability with a brazing filler metal that is higher than that of the oxide of the first metal member, and heating the brazing filler metal to melt the brazing filler metal to join the first metal member and the second metal member via the high-wettability metal.

The phrase “oxide is formed during brazing” used herein refers to the promotion of oxidation of the first metal member by heating when the brazing filler metal is melted, thereby forming an oxide on the first metal member. The oxide is usually formed on the surface part of the first metal member and, depending upon the type of metal making up the first metal member, can form an oxide covering film that covers the first metal member.

In the foregoing aspect, in the joining step, an oxide covering film made of the oxide on the surface of the first metal member may be formed on at least a part thereof onto which the high-wettability metal was not applied by heating in the joining step.

As noted above, when a brazing filler metal is melted on the surface of the first metal member onto which an oxide forms during brazing, because the molten brazing filler metal is repelled by the oxide formed on the surface of the first metal member by heating, partially poor joints are sometimes formed.

According to the above-noted method for brazing, before brazing, which is accompanied by heating in the joining step, a high-wettability metal is applied to at least the brazing surface of the first metal member (in the metal application step). In the joining step, the first metal member and the second metal member are joined by brazing, which is accompanied by heating, with brazing filler metal via the pre-applied high-wettability metal. That is, the wettability of the brazing filler metal at the brazing surface is improved, thereby reducing the formation of weak joints.

By leaving a surface on the first metal member to which the high-wettability metal is not applied, an oxide is formed on the surface when the surface is brazed (in the joining step), and further an oxide covering film is formed thereon to impart superior corrosion resistance to the first metal member.

In the foregoing aspect, the first metal member and the second metal member may be either the same type of metal or different types of metals, and if an oxide is formed on the second metal member as well, a high-wettability metal may be applied to the brazing surfaces of both to achieve an effect similar to the above-noted aspect.

The brazing method of the present invention that reduces poor joints may be employed in manufacturing a structure that requires that poor joining be inhibited at joining locations. According to the brazing method of the present invention, because good brazing is done even of members having high corrosion resistance, such as those on the surface of which an oxide covering film forms at a high temperature, the method may be applied to a structure requiring corrosion resistance. For this reason, the brazing method of the present invention may be applied to manufacturing, for example, of a structure of a stacked fuel reformer.

A second aspect of the present invention relates to a reformer in which a plurality of metal members made of first metal members and second metal members are stacked, wherein brazing is done by a brazing filler metal with the first metal members and the second metal members in the stacked condition. A feature of the reformer is that a high-wettability metal having a wettability higher than that of an oxide formed on the first metal member during brazing is interposed between the first metal member and the second metal member.

### BRIEF DESCRIPTION OF THE DRAWINGS

The foregoing and further objects, features, and advantages of the invention will become apparent from the following description of example embodiments with reference to the accompanying drawings, wherein like numerals are used to represent like elements, and wherein:

FIG. 1 is a schematic view showing an example of a brazing method according to an embodiment of the present invention;

FIG. 2 is a plan view of metal sheets forming the catalyst carrier base material of a stacked fuel reformer;

FIG. 3 is a cross-sectional view, cut along the thickness direction of the metal sheets, of a catalyst carrier base material of a stacked fuel reformer;

FIG. 4 is a photograph serving in place of a drawing, showing the cross-section of a metal plate onto the surface of which is formed a Ni covering film or an Fe covering film;

FIG. 5 is an enlarged partial cross-sectional view showing the placement of stacked metal sheets before heating in the joining step of the first embodiment, and the cross-section of the assembly fabricated by the brazing method of the first embodiment;

FIG. 6 is a drawing showing the cross-section of the assemblies fabricated by the brazing methods according to the first embodiment and according to the first comparison example;

FIG. 7 is a drawing showing the cross-section of the assembly fabricated by the brazing method according to the first comparison example; and

FIG. 8 is a graph showing the joint strength in the assemblies fabricated by the brazing methods according to the first embodiment and according to the first comparison example.

### DETAILED DESCRIPTION OF THE EXAMPLE EMBODIMENTS

Example embodiments of the present invention are described below to describe the brazing method of the present invention.

In the brazing method according to an embodiment of the present invention, a first metal member, on which an oxide forms during brazing, and a second metal member are brazed using a brazing filler metal. The metal of the first metal member is not particularly restricted, the brazing method of the present invention being effective if an oxide is formed during brazing and also if a small amount of oxide grows before brazing, regardless of the degree of formation of the oxide. For example, the first metal member may be a iron-based member made of an iron-based material having iron (Fe) as the main component. Because an iron-based member has superior heat resistance it may be used as a brazed member, and an oxide forms during brazing depending upon the elements added to the iron-based member. At least one of aluminum (Al), chromium (Cr), and silicon (Si) may be added to iron, the main component, in the iron-based member. When this is done, the oxide formed on the iron-based member includes at least one of Al, Cr, and Si.

The surface of the iron-based member is covered by at least one of an oxide covering film of Al, Cr, and Si by heating during brazing, depending upon the amount of Al, Cr, and Si added to the iron-based member. Because the iron-based member covered with an oxide covering film of at least one of Al, Cr, and Si achieves high corrosion resistance even in a high-temperature, high-humidity oxidizing atmosphere, this is suitable, depending upon the condition of use of the structure made by brazing. The amount of Al, Cr, and Si included in the iron-based member may be selected as appropriate to the condition of use of the structure. Because the resistance to heat and corrosion of an iron-based metal differs depending upon the type and amount of added element with which it is combined, although it is not possible in general to specify a preferable amount of additive, it is possible to cite an iron-based metal with iron as the main component containing Al in an amount of at least 3 wt % and further in the ranges from 3 to 7 wt % and from 4 to 7 wt %, an iron-based metal with iron as the main component containing Cr in an amount of at least 20 wt % and further in the ranges from 20 to 35 wt % and from 25 to 35 wt %, and an iron-based metal with iron as the main component containing Si in an amount of at least 5 wt % and further in the ranges from 5 to 9 wt % and from 7 to 9 wt %. If the amount of Al or the like is excessive, however, because of a decrease in workability and strength the iron-based metal may contain 50 wt % or greater iron. Because an iron-based metal containing less than 3 wt % Al exhibits the formation of island-shaped oxidation and a non-uniform oxide covering film, it is insufficient in terms of corrosion resistance in a high-temperature, high-humidity water gas atmosphere in particular. Also, in an iron-based metal containing less than 20 wt % of Cr and an iron-based metal containing less than 5 wt % Si, depending upon the conditions of use, the chromium oxide or silica film could be destroyed. For example, even if an iron-based metal having iron as the main component and containing at least 3 wt % Al is in an atmosphere at a high temperature of 900 to 1000° C. with water gas at 30 to 50%, the iron-based metal will exhibit superior corrosion resistance, with no destruction of the formed oxide covering film. Other iron-based metals exhibiting superior corrosion resistance include Fe-14Cr-1Al and Fe-20Cr-5Al (where the numbers indication wt %).

As noted above, the first metal member and the second metal member may be made either of the same or of different types of metals. For example, it is possible to use such combinations as a combination of a first metal member on which an oxide forms during brazing and a second metal member on which an oxide does not form during brazing, or a combination of a first metal member on which an oxide forms during brazing and a second metal member of a different type of metal but on which an oxide also forms during brazing.

The first metal member used with the brazing method of this embodiment of the present invention may be used with the surface as is, as long as it is not specially processed (such as by heat treating) to form an oxide thereon. If an oxide is formed on the surface thereof by special processing, it is desirable that the outermost surface of the first metal member that includes at least the brazing surface be removed before the metal application step as described below. For example, at least the brazing surface may be subjected to polishing, etching, or shot peening or the like to remove the oxide formed on the surface.

The brazing method according to this embodiment of the present invention has a metal application step and a joining step, each of which are described in detail below.

The metal application step is a step that applies a high-wettability metal to at least the brazing surface of the first metal member. The high-wettability metal has a wettability higher than that of the oxide formed on the first metal member during brazing. The phrase “brazing surface of the first metal member” used herein refers to the surface of the first metal member that opposes the second metal member, via the interposed brazing filler metal, after brazing. The high-wettability metal may be applied to at least the brazing surface.

The high-wettability metal has a higher wettability with the brazing filler metal than that of the oxide formed on the first metal member during brazing. As long as the high-wettability metal maintains a wettability that is greater than that of the oxide when compared with the brazing filler metal in the molten condition, there is no particular restriction with regard to the high-wettability metal. However, as described below, the applied high-wettability metal diffuses into the first metal member and/or the brazing filler metal when melted during brazing. For this reason, the high-wettability metal may be a metal that does not adversely affect the metal of the first metal member or the brazing filler metal even it is diffuses thereinto. For example, in the case of a first metal member that is an iron-based metal, when phosphorus (P) or boron (B) or the like diffuses into the first metal member, because of deterioration of the mechanical properties of the first metal member, the high-wettability metal may be one that substantially does not contain these elements.

Specifically, in the case of a first metal member made of an iron-based metal, nickel (Ni), iron (Fe), or an iron-based metal having iron (Fe) as a main component may be used as the high-wettability metal. In the case in which the first metal member made of an iron-based metal is brazed by a nickel-base brazing filler metal containing nickel (Ni), if nickel is used as the high-wettability metal there is, of course, no great adverse effect even if the nickel-based brazing filler metal diffuses into the first metal member. Also, if iron or an iron-based metal having iron as a main component is used as the high-wettability metal, there of course is no adverse effect of the first metal member, of course, on the nickel-based brazing filler metal. Although pure nickel or iron, which have high activity, may be used, other elements or impurities may be included, to the extent that the properties are not adversely affected. An Fe—Cr alloy or Fe—Cr—Ni alloy or the like may be used as the high-wettability metal having iron as a main component. However, if the high-wettability metal having iron as a main component includes at least one of aluminum, chromium, and silicon, the amount of these additives may be limited to prevent formation of oxide on the high-wettability metal itself during brazing. That is, the iron-based metals usable as a high-wettability metal are iron-based metals having a composition that is different from that of the first metal member. When the high-wettability metal is an iron-based metal, the amount of additive element may be 0 to 0.1 wt % in the case of aluminum, 0 to 14 wt % in the case of chromium, and 0 to 1 wt % in the case of silicon, or the high-wettability metal may substantially not include these elements.

The metal application step may be a step that applies the high-wettability metal at a temperature lower than the temperature at which an oxide forms on the first metal member. This is because, by maintaining a low first metal member temperature in the metal application step, it is possible to inhibit the formation of an oxide on the first metal member, and possible to achieve good adhesion of the high-wettability metal to the first metal member. Although the adhesion of the high-wettability metal depends upon the material of the first metal member, the temperature of at least the surface of the first metal member may be held to 500° C. or lower, and may be room temperature.

The metal application step involves the formation of a metal covering film made of a high-wettability metal. Although there is no particular restriction with respect to the method of forming the covering film, in order to apply a high-wettability metal at a temperature that is lower than the temperature at which an oxide forms on the first metal member, it is desirable to use a film formation method in which the temperature of at least the surface of the first metal member does not increase during film growth. Specifically, the cold spraying method, wide peening cleaning (WPC) processing, and the aerosol gas deposition method and the like may be cited as methods. Using these methods it is possible to hold the surface temperature of the first metal member to 500° C. or below during film growth. Of these methods, because the aerosol gas deposition method, which uses the low-temperature impact hardening effect, features high-speed growth of the film and achieves a fine pattern without etching, the aerosol gas deposition method may be used in the brazing method of the present invention. Additionally, because the aerosol gas deposition method generates fine metal particles with an average particle diameter of 1 to 20 nm from the raw material while growing a film on the surface receiving the film, it is possible to use the aerosol gas deposition method in the growth of a nickel covering film made of pure nickel or the growth of an iron covering film made of pure iron, which elements are highly reactive. Even when using a film growing method other than the ones noted above, it is possible to limit the increase in the temperature by such methods as cooling the first metal member.

When this is done, the covering film made of the high-wettability metal may have a film thickness of 10 μm or less and further may be 5 μm or less, or in the range from 1 to 2 μm. As described above, because the high-wettability metal diffuses into the first metal member and the like, if the film thickness is excessive, the composition of the metal of the first metal member and the like is sometimes affected. For this reason, the thinner the film of high-wettability metal, the better. Although inhibition of poor joining may occur even if there is a small amount of the high-wettability metal is applied to the first metal member, there is a greater inhibiting effect if the covering film is 1 μm or greater.

The joining step is a step that melts the brazing filler metal by heating and joins the first metal member and the second metal member as one via the high-wettability metal applied in the metal application step. In the joining step, when the first metal member and the second metal member are positioned at the prescribed joining position to join the members via the high-wettability metal, the brazing filler metal is applied to the brazing surface. The method of applying the brazing filler metal to the brazing surface may be a such method as the method of interposing a brazing foil between the brazing surface (to which the high-wettability metal is applied) of the first metal member and the brazing surface of the second metal member, the method of forming a brazing filler metal covering film on the brazing surface, or the method of coating a powdered brazing filler metal onto the brazing surface. The brazing filler metal may be applied to the brazing surface of the first metal member and the brazing surface of the second metal member using any method appropriate to the positioning therebetween. In addition, the brazing filler metal may be applied either before or after the two metal members are positioned. In any case, it is sufficient that the brazing filler metal be applied during the application step to the brazing surface to which the high-wettability metal is applied.

The first metal member and the second metal member positioned in the prescribed positions are joined together by melting the brazing filler metal. The method of melting the brazing filler metal may be either the method of partially heating mainly the joining location and may also be the method of heating the overall metal members. In either melting method, because the high-wettability metal is applied to the brazing surface of the first metal member beforehand, the reduction in the wettability due to heating is inhibited.

When the brazing filler metal melts during brazing, there is mutual diffusion between the first metal member and the high-wettability metal and between the high-wettability metal and the brazing filler metal. That is, in the joining step the first metal member and the second metal member are joined via the interposed high-wettability metal, and because of diffusion the high-wettability metal is diffused into the first metal member and the brazing filler metal after the completion of the brazing. As a result, a strong, stable joint is formed between the first metal member and the second metal member.

Because the brazing filler metal has a required heating temperature for brazing that depends on the melting point of the constituent components thereof, the brazing filler metal may be selected in accordance with the materials of the first metal member and the second metal member and the temperature of actual use (operating temperature). Japan Industrial Standards (JIS) and the like set forth standards for brazing filler metals, which can be selected appropriately by a person skilled in the art. For example, if the first metal member and the second metal member have low resistance to heat, a copper-based brazing filler metal containing copper (Cu) or a silver-based brazing filler metal containing silver (Ag) may be used. If the first metal member and the second metal member are, for example, iron-based members having a high heat resistance, a nickel-based brazing filler metal containing nickel may be used.

The joining step may be a step that forms an oxide covering film made of an oxide on at least a part of the surface of the first metal member to which the high-wettability metal is not applied by heating in the joining step. That is, if the high-wettability metal is applied only to the brazing surface, rather than the entire surface of the first metal member, the formation of an oxide on the surfaces of the first metal member to which the high-wettability metal is not applied when melting the brazing filler metal by heating, corrosion resistance is imparted to the first metal member. Depending upon the type of first metal member, the member may be formed with superior corrosion resistance, because of the formation of the oxide covering film. Stated differently, by leaving a portion of the surface of the first metal member, to which the high-wettability metal is not applied, it is possible to impart corrosion resistance to that surface.

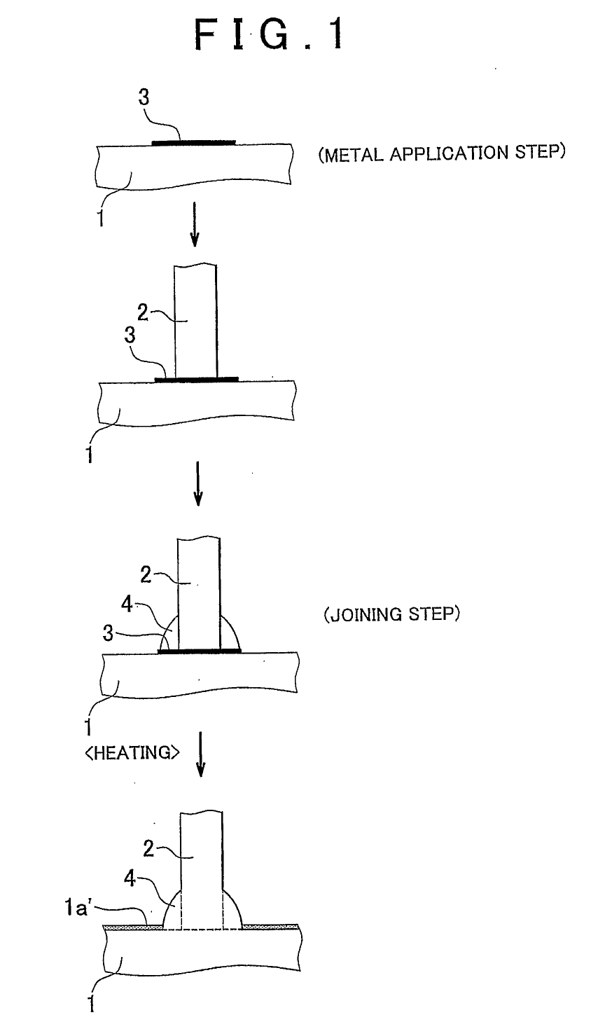

The foregoing brazing method according to the present invention is described below with reference to the accompanying drawings. FIG. 1 is a schematic view showing an example of a brazing method according to an embodiment of the present invention. In the brazing method shown in FIG. 1, the first metal member 1 on which an oxide is formed during brazing and the surface of the second metal member 2 (on which it is difficult for an oxide to form during brazing) are joined. In the metal application step, of the surface of the first metal member 1, a metal covering film 3 made of a high-wettability metal is formed on at least the brazing surface of the first metal member 1. Next, the second metal member 2 is positioned at a prescribed position and a brazing filler metal 4 is applied in a gap between the opposing metallic covering film 3 and the second metal member 2. In this condition, when overall heating is done up to the brazing temperature, the brazing filler metal 4 melts on the surface of the metallic covering film 3. Because the molten brazing filler metal 4 has good wettability with the metal covering film 3, it is not repelled from the surface of the metallic covering film 3. When this occurs, the first metal member 1, the second metal member 2, the high-wettability metal 3, and the brazing filler metal 4 exhibit mutual diffusion at each of the respective boundaries. When the molten brazing filler metal 4 coagulates, the first metal member 1 and the second metal member 2 are strongly joined together via the intervening high-wettability metal 3, and the high-wettability metal 3 is diffused into the first metal member and the brazing filler metal. Additionally, by heating the overall brazing filler metal to the brazing temperature, an oxide covering film 1a′ is formed on the part of the surface of the first metal member 1 onto which the high-wettability metal 3 is not applied. The part of the first metal member 1 surface on which the oxide covering film 11 is formed has superior corrosion resistance.

Although the foregoing description of each step mainly uses the case in which the oxide is formed on the first metal member during brazing, as noted above there are cases in which, depending upon the constitution of the second metal member, an oxide is formed on the second metal member as well. Therefore, by applying a high-wettability metal to the second metal member in the same manner as the first metal member, the same effect is achieved as is achieved for the first metal member. If, for example, the first metal member and the second metal member are made of the same type of metal, the metal application step may be a step that applies a high-wettability metal to at least the brazing surfaces of both the first metal member and the second metal member.

Because the brazing method of the present invention reduces poor joining when brazing is done to a highly corrosion-resistant metal onto which on oxide forms during the brazing, it may be used as a brazing method when manufacturing an exhaust gas purification catalyst or the carrier base material of a reformer, which are required to have corrosion resistance. Specifically, the first metal member and/or the second metal member are metal sheets having a plurality of grooves formed on at least one surface thereof, and the joining step joins a plurality of metal sheets, with the metal sheets in the stacked condition. With regard to the shape of the metal sheets, they may be sheet-like bodies having a plurality of grooves formed on at least one surface, formed with a plurality of grooves on both surfaces, or formed by bending a sheet into a wavy shape, and can otherwise have any shape. Examples that can be cited are a stacked metal carrier base material made by alternate stacking of a metal sheet having a plurality of grooves and a metal sheet having no grooves, and a coiled metal carrier base material made by brazing a band-shaped flat sheet made of a metal foil with a wavy band-shaped sheet extending in the longitudinal direction at the contact surface therebetween, after which winding is done in the longitudinal direction.

Of these, the brazing method of the present invention may be used in the manufacture of a fuel reformer that requires corrosion resistance and prevention of leaks at joints. A fuel reformer is usually made by alternate stacking of a reformed gas passage layer having a plurality of reformed gas flow passages supplied with a hydrocarbon-based fuel, and a fuel gas passage layer having a plurality of fuel gas flow passages supplied with fuel gas. An oxidizing reaction catalyst oxidizing the hydrocarbon-based fuel and a reforming reaction catalyst reforming hydrocarbon-based fuel to hydrogen-bearing gas are carried in these gas flow passages. According to the brazing method of the present invention, a plurality of gas flow passages are formed in a joined assembly obtained by stacking and joining a plurality of metal sheets having a plurality of grooves on at least one surface thereof, the passages being delineated by grooves formed between the metal sheets and adjacent metal sheets. The reformer (stacked fuel reformer) is formed by various catalysts carried on the inner surfaces of the gas flow passages of the joined assembly.

From the standpoint of heat resistance and corrosion resistance, it is desirable that the already-described iron-based member be used as the metal sheets (first metal members and second metal members) in such a fuel reformer. If an iron-based member is used, it is possible to achieve good formation of an oxide covering film on the surface of the gas flow passages by heating in the joining step, thereby preventing peeling of the carried catalyst accompanying the improvement in corrosion resistance.

The brazing method of an embodiment of the present invention is described above, although the brazing method of the present invention is not restricted to the foregoing embodiment. The brazing method of the present invention encompasses various changes and improvements made thereto by a person skilled in the art, within the scope and spirit of the present invention.

An embodiment of the brazing method of the present invention is described below, along with a comparison example.

### First Embodiment

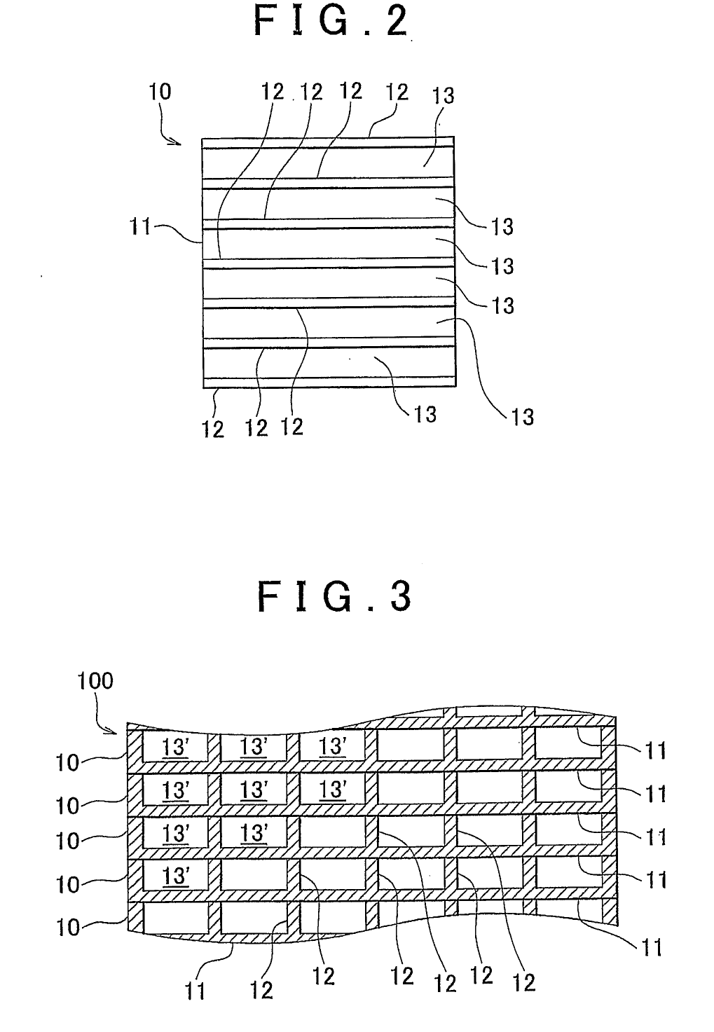

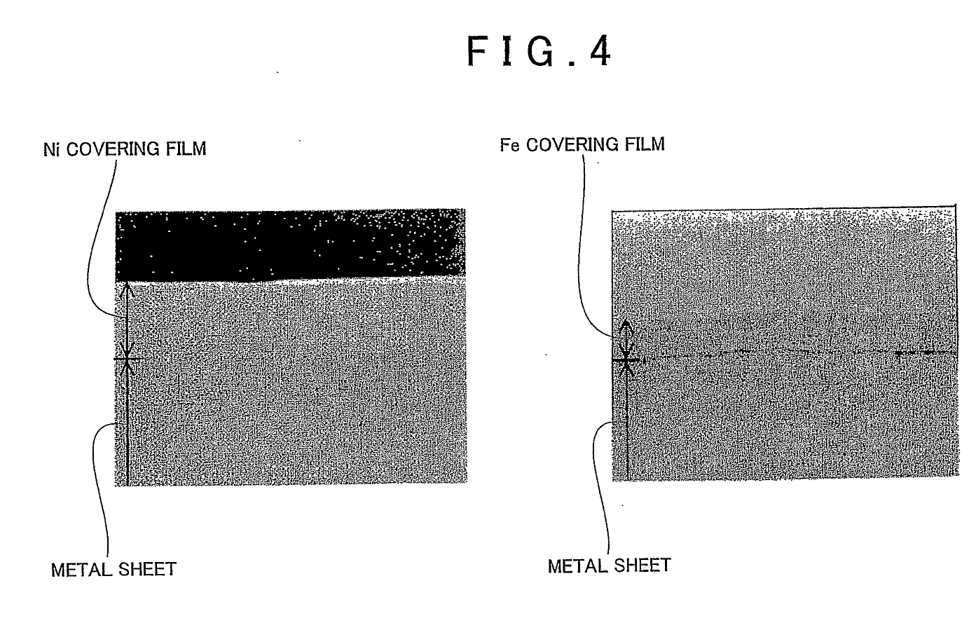

In the first embodiment, a metal sheet 10 made of stainless steel (Fe-20Cr-5Al; units of wt %) having a plurality of grooves 13 was prepared. In this embodiment, a plurality of metal sheets 10 are stacked in the thickness direction and adjacent metal sheets 10 are joined by brazing to form the catalyst carrier base material (becoming the joined assembly 100) of a stacked fuel reformer. FIG. 2 shows the plan view of the metal sheets 10 forming the catalyst carrier base material of a stacked fuel reformer, and FIG. 3 shows a cross-sectional view, cut along the thickness direction, of a plurality of the metal sheets 10. The metal sheets 10 have a plurality of grooves 13 delineated by the plurality of partition walls 12 on one surface of the bottom sheets 11. The thickness of the bottom sheets 11 and the partition walls 12 were approximately 300 μm. A plurality of the metal sheets 10 are stacked so that the edge surfaces of the partition walls 12 come into contact with the other surface (rear surface) of an adjacent metal sheet 10, thereby forming the gas flow passages 13′ delineated by the bottom sheets 11 and the partition walls 12. The brazing method is described in detail below.

[Metal Appling Step]

A nickel covering film having pure nickel as the raw material was grown on the brazing surface of the metal sheet 10 using the aerosol gas deposition method. The nickel covering film was pattern coated to obtain an approximate film thickness of 1 μm and an approximate width of 300 μm on the brazing surface of the bottom sheet 11 and the brazing surface of the partition wall 12 (corresponding to the edge surface of the partition wall 12). After film growth, there was no change in and formation of an oxide was not seen in the part of the surface of the metal sheet 10 on which the nickel covering film was not formed.

As a reference example, the cross-sections of a nickel covering film (film thickness 2 μm) and an iron covering film (thickness 0.5 μm) grown on the surface of the metal sheet 10 using the same procedure as noted above were observed using a scanning electron microscope (SEM). The nickel covering film and the iron covering film were formed as substantially uniform covering films on the surface of the metal sheet 10 and there was no peeling or the like observed.

[Joining Step]

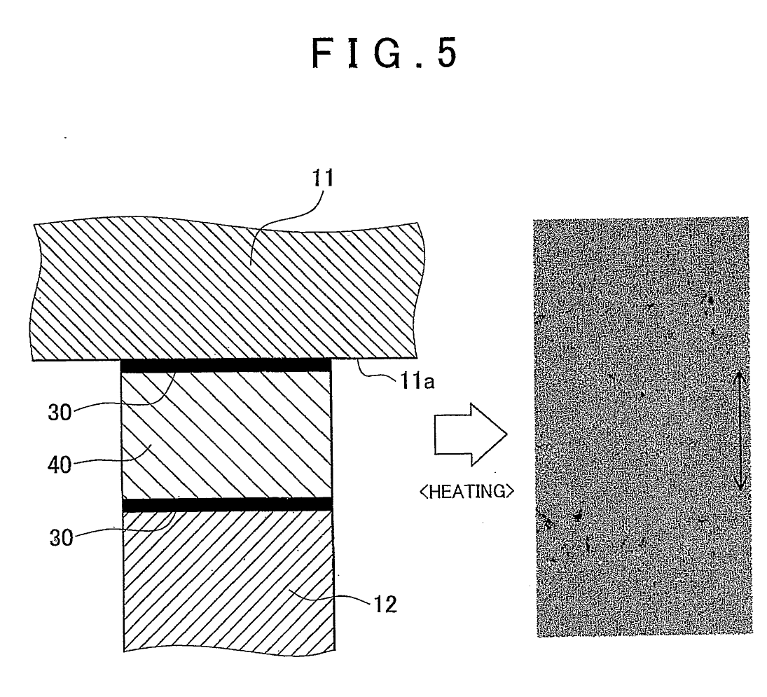

The plurality of metal sheets 10 onto which the nickel covering film was formed in the metal application step were stacked in the thickness direction. When the stacking is done, the edge surfaces of the partition walls 12 on which the nickel covering film is formed oppose the nickel covering films on the rear surfaces of the bottom sheets 11 of the another, adjacent metal sheet 10. When this was done, a nickel-based brazing foil 40 (BNi-5, thickness 35 μm) was sandwiched between the opposing nickel covering films as the brazing filler metal. FIG. 5 shows the placement of the metal sheets 10 and the brazing foil 40 (cross-sectional view at the left).

By heating this stacked assembly in an oven for 1 minute in air at a temperature of 1150° C., adjacent metal sheets were mutually joined. After this the joined assembly was obtained by cooling to room temperature.

In this embodiment it was verified that, in the joined assembly, an oxide covering film was formed on the surface 11a (FIG. 5) of the metal sheet 10 on which the nickel covering film was not formed.

### Comparison Example 1

A comparison example 1 was formed in the same manner as the first embodiment, with the exception that the nickel covering film was not formed (that is, no metal application step).

[Evaluation 1]

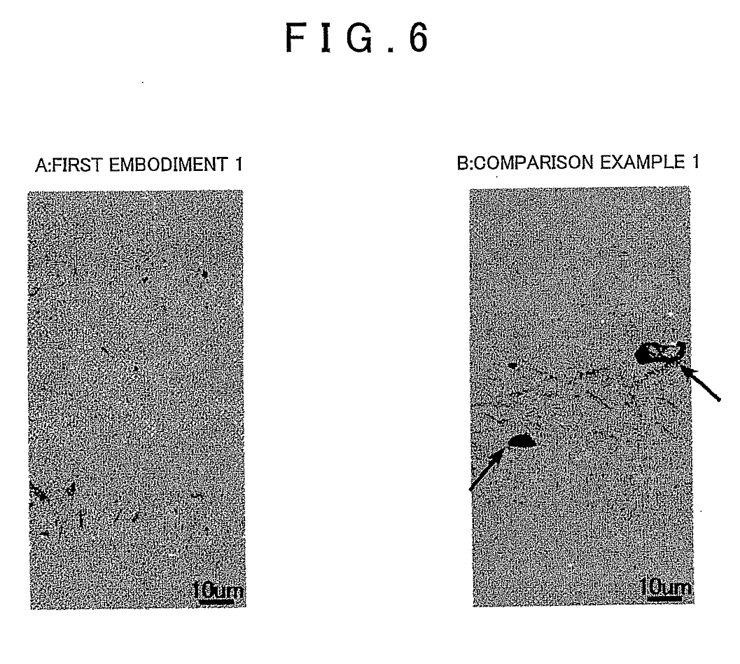

The cross-sections of joined assemblies fabricated using the brazing methods of the first embodiment and the comparison example 1 were observed. Hereinafter the respective joined assemblies are referred to as the joined assembly of the first embodiment and the joined assembly of the comparison example 1. An SEM was used in observing the cross-sections. The SEM image of the cross-section of the joined assembly of the first embodiment is shown in FIG. 5 (right photograph) and at A in FIG. 6, and the SEM image of the cross-section of the joined assembly of the comparison example 1 is shown at B in FIG. 6. The photograph in FIG. 5 and the photograph at A in FIG. 6 are one adsorption the same SEM image.

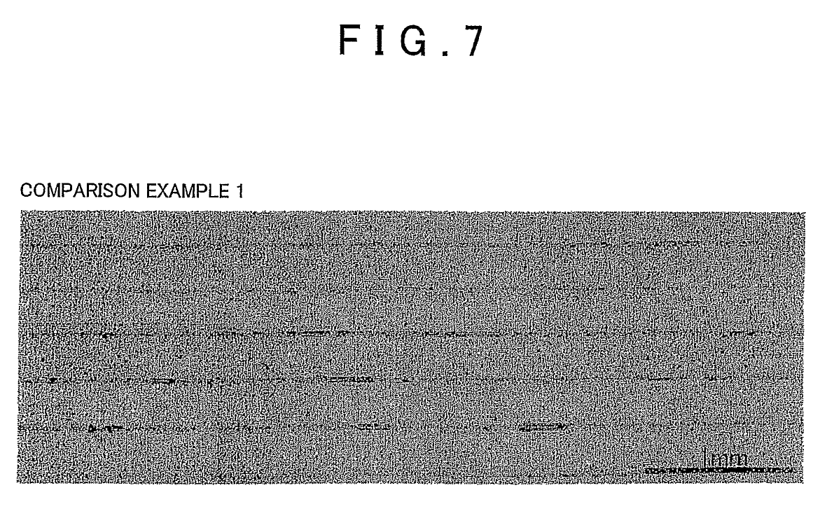

Pores (arrows in B of FIG. 6) were observed in the joined assembly of the comparison example 1. Additionally, upon observing the cross-section over a wide area using a metallurgy scanning electron microscope, the existence of partially poor joining was verified (FIG. 7). In the case of the joined assembly, however, of the first embodiment, no pores were observed (A of FIG. 6). Also, the boundaries between the metal sheet 10, the nickel covering film 30, and the brazing foil 40 disappeared, and the nickel covering film 30 disappears due to diffusion. As a reference, the width of the brazing foil 40 used in brazing is shown in the photo on the right of FIG. 5.

[Evaluation 2]

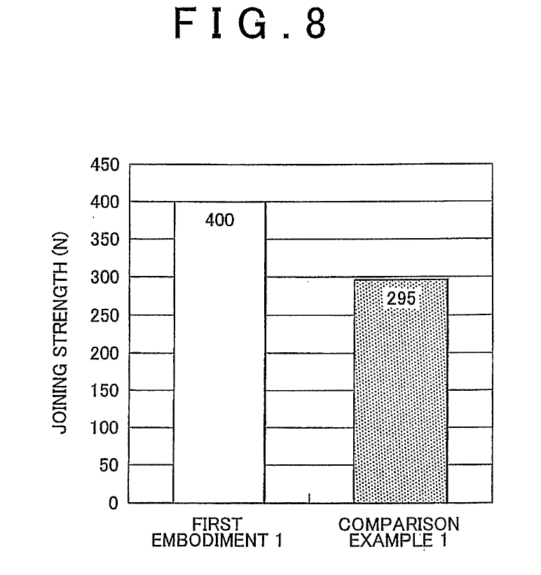

The joint strength of the joined assemblies of the first embodiment and the comparison example 1 were measured by peel test using an L-shaped joint. The peel test was performed using test samples for both the first embodiment and the comparison example 1 having a joining surface area (surface area of the brazing surface) of 40 mm×40 mm and bending leeway of 20 mm, the evaluation done with a pulling speed of 2 mm/minute. The results are shown in FIG. 8. The joined assembly of the first embodiment had a higher joint strength than the joined assembly of the comparison example 1.

Thus, the brazing method of the present invention improves the wettability of the brazing filler metal by forming a nickel covering film before the joining step to reduce poor joining.

1-23. (canceled)

24: A method for brazing a first metal member that is an iron-based member having iron as a main component and containing at least one of aluminum, chromium, and silicon, on which an oxide forms during brazing and the oxide contains at least one of aluminum, chromium, and silicon, and a second metal member, wherein a high-wettability metal which is selected from nickel, iron, or an iron-based metal with a brazing filler metal that is higher than that of the oxide is applied to at least a brazing surface of the first metal member at a temperature lower than the temperature at which the oxide forms on the first metal member, and the first metal member and the second metal member are joined via the high-wettability metal, the method comprising:
applying the brazing filler metal, which is selected from nickel-based brazing filler metal, copper-based brazing filler metal, or silver-based brazing filler metal, to the brazing surface to which the high-wettability metal is applied; and
heating the brazing filler metal to melt the brazing filler metal, wherein
the oxide covering film is formed by heating during the joining on at least a part of the surface of the first metal member to which the high-wettability metal is not applied.

25: The brazing method according to claim 24, wherein the oxide covering film covers the total surface of the iron-based member.

26: The brazing method according to claim 24, wherein the first metal member has iron as a main component and contains aluminum in an amount of at least 3 wt %.

27: The brazing method according to claim 26, wherein the amount of aluminum contained in the first metal member is 7 wt % or less.

28: The brazing method according to claim 24, wherein the first metal member has iron as a main component and contains chromium in an amount of at least 20 wt %.

29: The brazing method according to claim 28, wherein the amount of chromium contained in the first metal member is 35 wt % or less.

30: The brazing method according to claim 24, wherein the first metal member has iron as a main component and contains silicon in an amount of at least 5 wt %.

31: The brazing method according to claim 30, wherein the amount of silicon contained in the first metal member is 9 wt % or less.

32: The brazing method according to claim 26, wherein the first metal member contains iron in an amount of at least 50 wt %.

33: The brazing method according to claim 24, wherein the first metal member and the second metal member are the same type of metal, and wherein the high-wettability metal is applied to at least the brazing surfaces of the first metal member and the second metal member.

34: The brazing method according to claim 24, wherein the high-wettability metal is applied by forming a covering film made of the high-wettability metal.

35: The brazing method according to claim 34, wherein the metal covering film is formed by growing the covering film on at least the first metal member using an aerosol gas deposition method.

36: The brazing method according to claim 24, wherein the high-wettability metal contains traces of aluminum, silicon, and chromium.

37: The brazing method according to claim 36, wherein the aluminum, silicon, and chromium contained in the high-wettability meta are contained in amounts of no greater than 0.1 wt %, no greater than 1 wt %, and no greater than 14 wt %, respectively.

38: The brazing method according to claim 24, wherein the brazing filler metal is a nickel-based brazing filler metal that contains nickel.

39: The brazing method according to claim 24, further comprising removing the outermost surface of the first metal member that includes at least the brazing surface, before the high-wettability metal applying.

40: The brazing method according to claim 24, wherein the first metal member and/or the second metal member is a metal sheet including a plurality of grooves formed on at least one surface thereof, and wherein the joining joins a plurality of metal sheets as one, with the metal sheets in the stacked condition.

41: The brazing method according to claim 34, wherein a thickness of the covering film made of the high-wettability metal is at least 1 μm and no greater than 10 μm.

42: A reformer comprising a catalyst on a stacked structure obtained by the brazing method according to claim 40.

43: A reformer in which a plurality of metal members made by laminating the first metal member and the second metal member and in which the first metal member and the second metal member are joined in the stacked condition as one by the brazing method according to claim 24, comprising:
a high-wettability metal, having a wettability with a brazing filler metal that is higher than that of the oxide formed on the first metal member during brazing, that is mixed during the brazing with the brazing filler metal and interposed between the first metal member and the second metal member.

44: The reformer according to claim 43, wherein the first metal member carries a reforming reaction catalyst that reforms hydrocarbon-based fuel into a hydrogen-bearing gas, and wherein the second metal member carries an oxidizing reaction catalyst that oxidizes a hydrocarbon-based fuel.

45: The reformer according to claim 43, wherein the first metal member and/or the second metal member is a metal sheet including a plurality of grooves formed on at least one surface thereof.

46: The reformer according to claim 43, wherein the high-wettability metal is applied to at least a brazing surface of the first metal member.
